(19) United States
(12) Patent Application Publication
(10) Pub. No.: US 2005/0081652 A1
(43) Pub. Date: Apr. 21, 2005

(54) Load Cell Having Improved Linearity and Temperature Transient Behavior

(76) Inventors: Jon Scott, Greenville, SC (US); Tom Leahy, Greenville, SC (US); Philip Mariani, Spartanburg, SC (US)

Correspondence Address: JEFFREY FURR, 253 N. MAIN STREET, JOHNSTOWN, OH, 43031, US

(21) Appl. No.: 10/605,713

(22) Filed: Oct. 21, 2003

(51) Int. Cl. G01L 1/04

(52) U.S. Cl. 73/862.632

(57) ABSTRACT

A new load cell design that is a combination of the column cell and proving ring designs while having the best features of both. The proving ring geometry is used to boost the transverse gage output giving tension and compression strain measurements that are more equal than in a column cell, while the gage placement is the same as a typical column cell, giving a superior temperature transient behavior. The device retains the high stiffness characteristics of column cells.

### BACKGROUND OF INVENTION

1. Field of the Invention

This invention relates to load cells and more particularly to a load cell that provides improved linearity and temperature transient behavior.

2. Description of Prior Art

Tensile and compressive forces today are measured with a wide variety of technologies. Most of the lowest cost designs use strain gages and many designs exist. One of the oldest and most popular strain gage designs is the column load cell. Columns usually have a long, slender elastic member loaded along its long axis in either tension or compression. Strain gages are affixed to the elastic member in such a way that both the longitudinal and transverse strains can be measured and combined to produce a total output proportional to the load. These devices usually assume that strain gages perfectly measure strain and that strain is proportional to load, so the output is assumed to be directly proportional to load.

Unfortunately, if the output of a real column cell is plotted against load, the plotted curve is not straight (nonlinear). The value of the nonlinearity is often observed to be 500-1000 ppm.

Most users of column load cells want an output curve having a nonlinearity which is less than 300 ppm and many even want it less than 50 ppm. To achieve this level of straightness in the output curve, a variety of methods are used. One method is to change the Wheatstone bridge excitation voltage as a function of load. This method often relies on a semiconductor strain gage mounted on the load cell, whose resistance changes greatly with strain and is used to change the excitation voltage. The semiconductor strain gages introduce almost as many problems as they solve, however. They are expensive, difficult to handle during manufacture and prone to large resistance changes with temperature.

Another method is to build a computer into the load cell. The computer's software can be used to straighten the output curve, plus provide correction for other cell errors. The computer method is widely regarded as being the most accurate and routinely produces cells having errors less than 50 ppm. Short of using a computer, methods have also been tried using active circuits (operational amplifiers) to obtain linearity correction. However, both computers and active circuits restrict the user in terms of either the power requirements, signal outputs, or both.

It is commonly believed that the change in dimensions of a column cell's elastic member is responsible for its nonlinear output curve. For example, if a column cell with a circular cross section is loaded in compression, the diameter at zero load is smaller than its diameter with any load applied. A greater diameter implies a stiffer elastic member and less deflection for the same load increment. Additional increments of load cause corresponding smaller strains, so that a load increment at full capacity of the load cell should cause less output than the same increment applied at zero load.

Another common explanation for a column's nonlinear output concerns the way the tensile and compressive strains are combined to form the total output signal. A Wheatstone bridge is often used to combine the longitudinal strains (compressive, for a cell in compression) and transverse strains (tensile, for a cell in compression). A Wheatstone bridge is used because it is inexpensive and can compensate for many scenarios in which some strain gages might be at different temperatures from other gages, as well as compensating for other problems. However, if the tensile and compressive strains are unequal in absolute value, then the Wheatstone bridge will give an output which is nonlinear even if the strains themselves are perfectly linear. This effect is well known and published by strain gage manufacturers in their product data.

Mathematical modeling of the diameter change and the Wheatstone bridge nonlinearities is unable to predict a total cell output which matches experimental measurements. These effects are simple and easy to quantify, yet they do not explain the nonlinear output of real load cells. For example, the bridge nonlinearity for a typical cell might be about 200 ppm, while the change in diameter causes a nonlinearity of about +180 ppm. These nonlinearities add to cause a predicted nonlinearity of about 20 ppm, but the actual load cell displays nonlinearities of +500 to +1000 ppm, with +800 ppm being a typical value. Otherwise identical manufacturing methods routinely produce cells having a variation in linearity in the aforementioned +500 to +1000 ppm range, but such a large change variation is also unexplained using the diameter change and Wheatstone bridge nonlinearities. This suggests that other sources of nonlinearity must exist in real column load cells, in addition to the ones commonly mentioned.

Further work on mathematical modeling suggests that the strain gage itself is nonlinear. It can easily be shown that strain gages are nonlinear and the nonlinearity is dependent on many factors, some that are well understood and some that are not. Several strain gage manufacturers sell gages which exhibit very different linearity and hysteresis performances when installed on the same load cell. Therefore, it is clear that the strain gages themselves are nonlinear and the degree of nonlinearity varies from batch to batch of gages and from gage type to gage type.

If strain gages are wired into a Wheatstone bridge and the absolute values of their strains are equal, it can be shown that the output of the bridge is almost perfectly linear with strain, whether the gages are linear or nonlinear. This of course assumes the strains themselves are perfectly linear. This relationship holds for most reasonable values of nonlinearity from commercially available strain gages. However, if the absolute values of the strains on the four arms of the bridge are unequal, then the output of the Wheatstone bridge is much more nonlinear. This is the fundamental flaw in commercially available column load cells: the strains they measure in the transverse direction are usually about −0.3 (Poisson's ratio) times the strain in the longitudinal direction. The smaller strain magnitude yields a bridge output which is nonlinear and varies depending on the nonlinearity of the gages used to build it.

An old design called a proving ring measures tension or compression forces. This device is essentially a metal ring with alternating locations of tensile and compressive strain around the ring's circumference. This device has excellent linearity, in that the magnitudes of tensile strain are equal to those of compressive strain. Unfortunately, this device exhibits such poor behavior in the presence of temperature changes that it isn't practical for commercial load cells. The primary cause of its temperature problems is that the tension and compression gages are usually not close to each other and are often mounted on metals of different thicknesses, so that the temperatures of the tension and compression gages are usually unequal.

Beam load cells are common in the market and have excellent linearity and temperature performance. These devices are designed to be placed in shear (and possibly bending) during loading, and generally have a large dimension transverse to the loading direction. The requirement for shear loading also places significant demands on their mounting: the mounting must be capable of sustaining the moments applied during shear loading. Their size transverse to the loading direction and the mounting requirements often make them an unattractive option compared to column load cells.

A special type of beam load cell is commonly called an S cell, due to it having a shape like the letter “S”. This cell is bent such that it has mounting requirements no more stringent than a column cell. However, it continues to possess a large dimension transverse to the loading direction as do beam cells. For designs needing a minimum size, they are no better than beam load cells.

### SUMMARY OF INVENTION

An object of the present invention is to provide a means to improved linearity in a column load cell while retaining the column load cell's favorable temperature transient behavior.

The inventor of the present invention has come up with a new load cell design. This new design is a combination of the column cell and proving ring designs while having the best features of both. The proving ring geometry is used to boost the tension gage output (for a cell in compression) giving tension and compression strain measurements that are more equal in absolute value than in a column cell, while the gaging arrangement is similar to a typical column cell, giving the column cell's superior temperature transient behavior.

### BRIEF DESCRIPTION OF DRAWINGS

Without restricting the full scope of this invention, the preferred form of this invention is illustrated in the following drawings:

FIG. 1 is a side elevational view of a column load cell;

FIG. 2 is a side elevational view of a column load cell embodying the present invention;

FIG. 3 is a cross-section view of a load cell in FIG. 4 embodying the current invention;

FIG. 4 is a side elevational view of a column load cell embodying an alternative of the present invention;

FIG. 5 displays the load cell in FIG. 4 connected to a chain; and

FIG. 6 is a side elevational view of an S-cell load cell.

### DETAILED DESCRIPTION

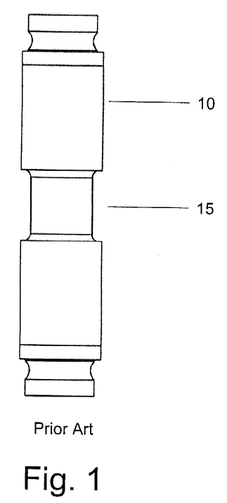

Referring initially to FIG. 1, there is shown an elevational side view of a column load cell 10. This design is popular because it is inexpensive to machine and to apply gages. For the end user, the mounting requirements are simple, the cell takes up little room in the transverse direction and it is very stiff. For compressive loads, the weight is usually applied to its spherical ends and for tensile loads, threaded ends or chain connections are often added. Unfortunately, the column load cell 10 often displays a nonlinearities of +500 to +1000 ppm with +800 ppm being a typical value.

The current invention was discovered by searching for the cause of the column load cell's 10 nonlinear behavior. This discussion refers to a column load cell 10in compression, although the same argument would apply for a column in tension, with the tensions becoming compressions and the compressions becoming tensions. In compression, the column shortens and strain gages 20 mounted longitudinally on the column measure the strain due to shortening. Other strain gages 20 are mounted in the transverse direction and measure a tensile strain, usually having a magnitude equal to Poisson's ratio for the column material times the longitudinal compressive strain. Usually two gages measure the compressive longitudinal strain and two gages measure the tensile Poisson strain and all four gages are combined into a Wheatstone bridge to produce a total output. Wheatstone bridges are well known in the industry.

The problem with this design is most real strain gages have resistances that are not linearly related to the strain. Usually, it is assumed that the resistance change with strain is linear, but this is only an approximation. It is trivial to show that the output of a Wheatstone bridge will be nonlinear with strain if the gages inaccurately report mechanical strains as being nonlinear with load, even if the true mechanical strains are perfectly linear with load. Real mechanical strains are seldom perfectly linear, so the error due to gage nonlinearity adds in a fashion to the error from nonlinearities in the mechanical strains.

For the case of the strain magnitudes in all four arms of the Wheatstone bridge being the same, it can be shown that the bridge will almost perfectly cancel the gages' nonlinearity in converting strain to a resistance change. The typical column cell 10, however, has strain magnitudes in the four arms which are unequal and related by Poisson's ratio. The more unequal the strains, the worse the nonlinearity cancellation becomes, so that most column cells 10 have a nonlinearity with load that is very poor.

The output of a Wheatstone bridge will also be nonlinear with strain even if the gages 20 are perfectly linear and the mechanical strains are perfectly linear for the case where the absolute strain values are unequal. This is the well-documented effect shown in strain gage manufacturers' handbooks. However, this nonlinearity is usually smaller than that caused by the nonlinearity in the gages themselves. In fact, this nonlinearity would not be a problem for linear gages, since it is almost perfectly compensated by the nonlinearity in the real mechanical strains caused by the growth in diameter of a column under compression. Therefore, the present invention corrects not for this well-documented error, but for the mostly unregarded problem of a nonlinearity in the strain gages themselves. The present invention also makes no attempt to correct for the nonlinearities in the real mechanical strains.

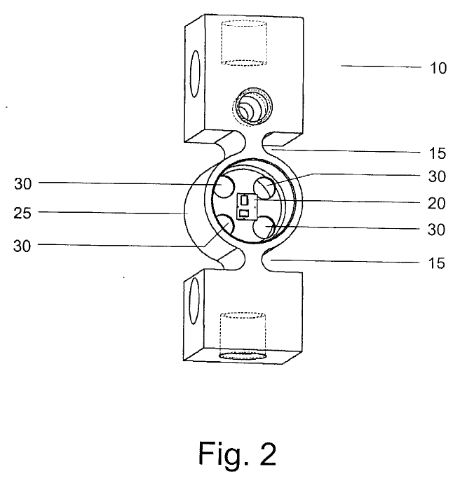

FIG. 2 shows a design which addresses the problems in the column cell 10 in FIG. 1. Gages 20 are mounted in a longitudinal and transverse direction as in a standard column cell. Gages 20 are mounted on both sides of the gaging surface, shown as a thin gaging web 15 in FIG. 1. The round body 25 functions similar to a proving ring, in that the round shape of the body tries to bulge outward under compressive loads, or collapses towards the gages 20 for tensile loads. This change in shape of the round body is only restrained by the gaging web 15, so that the transverse strains in the gage web 15 are greatly enhanced over their value if the round body 25 were absent. The web serves to stiffen the round body 25, but in so doing the round body 25 imparts its greater strains to the gaging web 15. The holes 30 in the surface on which the gages 20 are mounted further enhance the longitudinal strain and the transverse strain, by both weakening the gaging web 15 and funneling the large strains over the narrow area occupied by the strain gages 20. For this design, the transverse gages experience about 0.8 times the longitudinal strain, compared with about 0.3 for the column cell 10 in FIG. 1.

It is trivial to show that increasing the output of the transverse gages so that their absolute output becomes closer to that of the longitudinal gages reduces the bridge nonlinearity caused by nonlinear strain gages. In fact, if the transverse gage output becomes equal to the longitudinal gage output, the Wheatstone bridge nonlinearity due to gage nonlinearity becomes almost zero. For most gages and strain levels, the overall Wheatstone bridge nonlinearity for equal strains is on the order of about 2-3 ppm. It is negligible compared to a 50 ppm tolerance which is suitable for most column cell applications and becomes small compared to mechanical nonlinearities in the load cell design. The overall Wheatstone bridge nonlinearity then becomes a balance of that contributed by the gage nonlinearity, mechanical nonlinearity and the Wheatstone bridge nonlinearity which stems from having unequal strains, even if those strains themselves are linear.

Another advantage of the present invention is that changes in the gage nonlinearity from batch to batch of gages 20 influence the overall cell nonlinearity to a lesser degree. If the cell design generates equal absolute strain, then the difference in overall cell nonlinearity due to gage nonlinearity changes would be only 2-3 ppm. However, most practical designs will have unequal strains due to cost and other considerations. A design having transverse strain that is 0.8 times the axial longitudinal strain will have considerably better immunity to gage differences than the typical ratio of 0.3 found in most commercial transducers. The effect is one of degrees of improvement, so a design having a transverse strain of 0.5 times the longitudinal strain will be better than one with a ratio of 0.3, but worse than one with a ratio of 0.8.

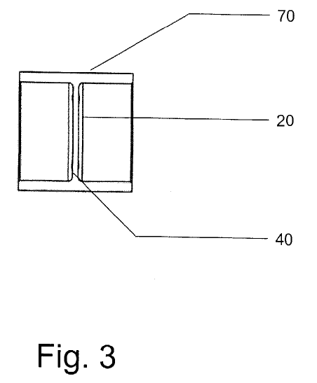

FIG. 3 shows a cross section through the strain gages 20 and gaging web 15 of the cell 60 in FIG. 2. The gages are mounted on a flat surface 40, although other arrangements are possible. An advantage of this design is that all four strain gages 20 are mounted very close together, so that they should all be at about the same temperature, even if the temperature on the load cell 60 is changing. Having the four gages 20 at the same temperature is advantageous, in that a Wheatstone bridge can be used to cancel their change in resistance due to temperature.

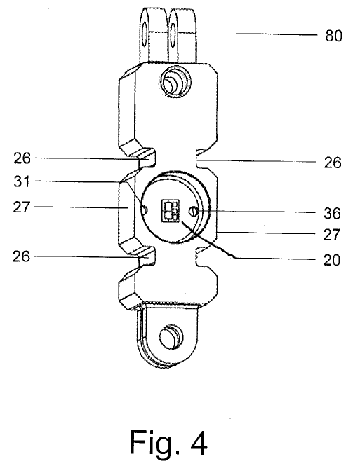

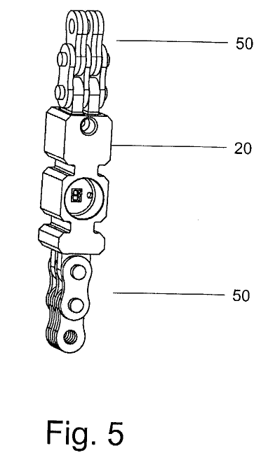

FIG. 4 shows another possible variation of the cell design in FIG. 2. In this cell 80, the curves 25 have been replaced by notches 26 and straight sides 27. The four holes 30 in FIG. 2 have been replaced with two holes 31 here. Although this design does not perform as well as the one in FIG. 2, it can be produced at considerably lower cost and the degradation in performance from that in FIG. 2 is acceptable for some applications. This design also has been modified for tension loading instead of compression loading, which shows that the method works equally as well in tension as in compression. FIG. 5 shows this design in a typical application measuring tension in a chain 50.

Although not shown, it would be possible to place rounded ends on either the design in FIG. 2 or FIG. 4 and produce a cell that would replace the column cell in FIG. 1. Such a cell would have equal performance to the one in FIG. 1, but without using a computer, active circuit, semiconductor strain gage or other method for linearity compensation.

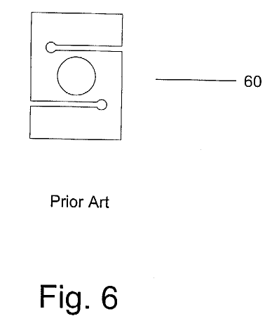

FIG. 6 shows a typical S-cell 60 design. This design is popular in the marketplace because all four strain gages have the same absolute strain and the device has excellent linearity as a result. Furthermore, temperature changes tend to cause a temperature gradient across the round gaging hole, a situation in which the Wheatstone bridge can easily reject temperature gradients. Although this cell has excellent performance, its shape is often a problem. Cutting the long slots is expensive. The width of the cell necessary to produce the slots means the S-cell 60 is usually very wide. The present invention can have performance equalling that of an S-cell 60, but in a considerably smaller package. This saves material and machining costs and takes up less room in the end user's installation.

Another advantage of the present invention over S-cells 60 is greater stiffness. S-cells 60 tend to have large deflections, as internal portions of the cell are in both shear and bending. The present invention has little bending and most of it is in uniaxial tension or compression. For this reason, the present invention has much higher stiffness than S-cells 60 of the same capacities.

Advantages

The previously described embodiments of the present invention including achieving a load cell that provides improved linearity and temperature transient behavior. These cells tend to have the stiffness and package size of a column cell, but the linearity and temperature performance of S-cells. The electronics are no more sophisticated than a Wheatstone bridge. Heretofore, obtaining all these traits in one load cell has been difficult without using a computer, active circuits, semiconductor strain gage or other method.

Although the present invention has been described in considerable detail with reference to certain preferred versions thereof, other versions are possible. Therefore, the point and scope of the appended claims should not be limited to the description of the preferred versions contained herein.

1. A device comprising:
a) load cell;
b) with notches in the side of said load cell to equalize the strains on the load cell when an applied load is applied.

2. A device as claimed in claim 1 wherein material is removed from the load cell sides to form said notches.

3. A device as claimed in claim 1 wherein material is removed from the load cell sides above and below the strain gage to from said notches.

4. A device as claimed in claim 1 which has a strain gage connected to the load cell.

5. A device as claimed in claim 1 which has a strain gage located on a surface of the load cell that is perpendicular to the load cell.

6. A device as claimed in claim 5 wherein material is removed from said surface.

7. A device as claimed in claim 1 which has a connecting means on the top and bottom of said load cell.

8. A device as claimed in claim 1 which has an attachment hole.

9. A device as claimed in claim 1 which has strain gages combined to form a Wheatstone bridge.

10. A device as claimed in claim 1 in which large strains generated by one body are imparted to another body on which strain gages are mounted, increasing the transverse strain at the gage location on the second body above that which could be achieved with Poisson's ratio.

11. A device comprising:
a) load cell;
b) with curves in the side of said load cell to equalize the strains on the load cell when an applied load is applied.

12. A device as claimed in claim 11 wherein material is removed from the load cell sides to form said notches.

13. A device as claimed in claim 11 wherein material is removed from the load cell sides above and below the strain gage to from said notches.

14. A device as claimed in claim 11 which has a strain gage connected to the load cell.

15. A device as claimed in claim 11 which has a strain gage located on a surface of the load cell that is perpendicular to the load cell.

16. A device as claimed in claim 15 wherein material is removed from said surface.

17. A device as claimed in claim 11 which has a connecting means on the top and bottom of said load cell.

18. A device as claimed in claim 11 which has an attachment hole.

19. A device as claimed in claim 11 which has strain gages combined to form a Wheatstone bridge.

20. A device as claimed in claim 11 in which large strains generated by one body are imparted to another body on which strain gages are mounted, increasing the transverse strain at the gage location on the second body above that which could be achieved with Poisson's ratio.
